(19) United States
(12) Patent Application Publication
(10) Pub. No.: US 2014/0360283 A1
(43) Pub. Date: Dec. 11, 2014

(54) PADEYE TESTER

(71) Applicants: Jakub Kawka, Perth (AU); Robert Friedrich Schmitz, Perth (AU)

(72) Inventors: Jakub Kawka, Perth (AU); Robert Friedrich Schmitz, Perth (AU)

(73) Assignee: PROSERV OFFSHORE PTY LTD, West Perth (AU)

(21) Appl. No.: 14/360,485

(22) PCT Filed: Nov. 24, 2011
(86) PCT No.: PCT/AU2011/001513

§ 371 Date: Aug. 22, 2014

(51) Int. Cl. G01N 3/10

(52) U.S. Cl. CPC G01N 3/10
USPC 73/837; 73/826

(57) ABSTRACT

A padeye tester is used for testing the condition of padeyes on underwater structures. The padeye tester has a frame having feet to engaged with an underwater structure, and a hook for engaging with a pad eye. The hook is moved under hydraulic pressure to provide a tensile force on the padeye, and the response to this tensile force indicates the padeye condition.

### FIELD OF THE INVENTION

The present invention relates to the testing of padeyes on subsea structures and equipment, and components thereof.

### BACKGROUND TO THE INVENTION

Subsea structures, such as those used in the oil-and-gas industries, may be positioned deep below the ocean surface, and may stay in this position for many years. Nonetheless, it may be necessary to ultimately recover the subsea structure, or components thereof, and to return it to the surface.

When the item to be recovered is relatively deep, it becomes necessary to use a Remotely Operated Vehicle (ROV) in order to reach the item. With this in mind, subsea structures and components are generally equipped with a padeye, onto which a cable can be attached during deployment, and onto which an ROV can readily attach a cable for subsequent retrieval.

Subsea items are subject to weakening and wear due to a number of factors, including corrosion and erosion. During retrieval of a subsea item there can often be large stress concentrations through the padeye. When the padeye has become sufficiently weakened over time, the possibility of padeye failure is greatly increased.

Failure of a padeye during the early stages of item retrieval—for instance, when a cable is initially tensioned—can add significantly to the costs and times of retrieval. Failure of a padeye during retrieval, when the item is some distance from the seabed, can lead to loss of the item.

The present invention has been constructed with this in mind. The present invention proposes the testing of a subsea padeye in situ, prior to the commencement of retrieval operations. The invention proposes a testing unit which is ROV deployable, and which will provide an advance indication of the fitness or otherwise of the padeye for use in retrieval operations.

### SUMMARY OF THE INVENTION

According to one aspect of the present invention there is provided a padeye tester, the padeye tester having: a frame, the frame including engagement feet for engaging with an item; and a padeye engager, the padeye engager arranged to engage with a padeye fixed to the item; the padeye engager being arranged to move relative to the frame such that a tensile force can be applied to the padeye; the padeye tester having a control means whereby the degree of tensile force applied can be controlled.

Preferably, the padeye tester includes a gauge whereby any changes in the resistance to the applied force—for instance, due to yielding of the padeye—can be determined.

It is preferred that the padeye engager be moved by means of hydraulic pressure.

In a preferred embodiment, the frame is substantially V-shaped, with engagement feet located on both a front leg and rear leg of the frame. It is further preferred that the padeye engager be associated with a central portion of the frame, located between the front leg and the rear leg.

The padeye engager may be coupled to a hydraulic cylinder located atop the central portion of the frame.

### BRIEF DESCRIPTION OF THE DRAWINGS

It will be convenient to further describe the invention with reference to preferred embodiments of the present invention. Other embodiments are possible, and consequently the particularity of the following discussion is not to be understood as superseding the generality of the preceding description of the invention. In the drawings:

FIG. 1 is a perspective of a padeye tester in accordance with the present invention;

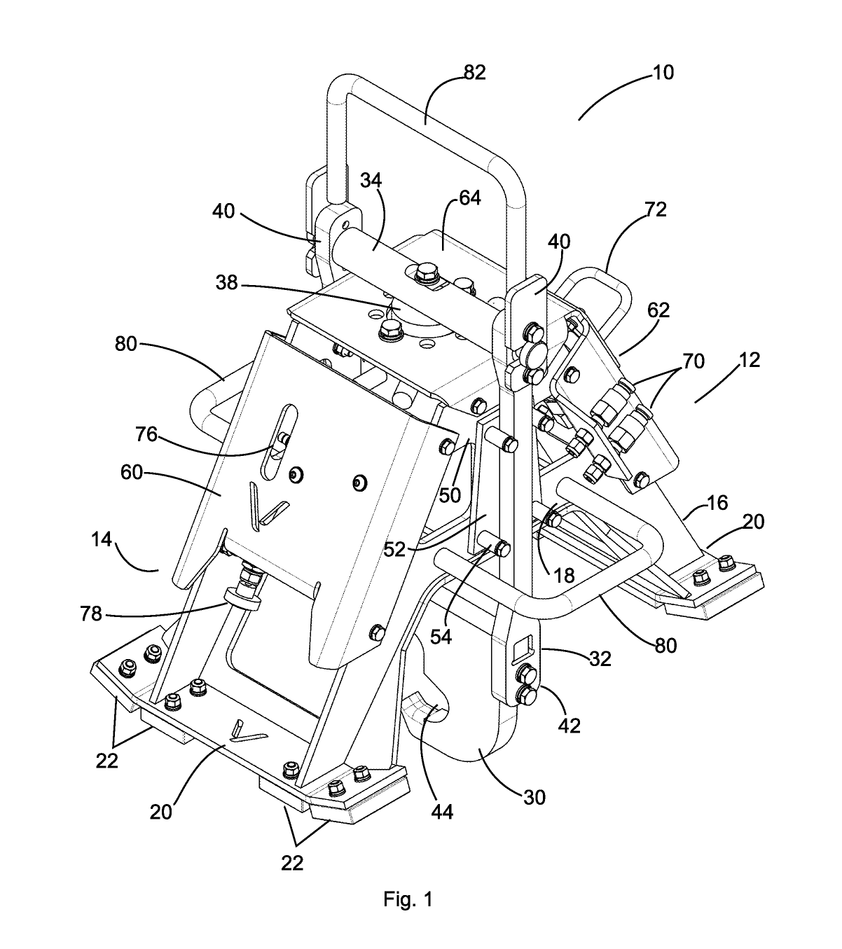

FIG. 2 is a perspective from the other side of the padeye tester of FIG. 1;

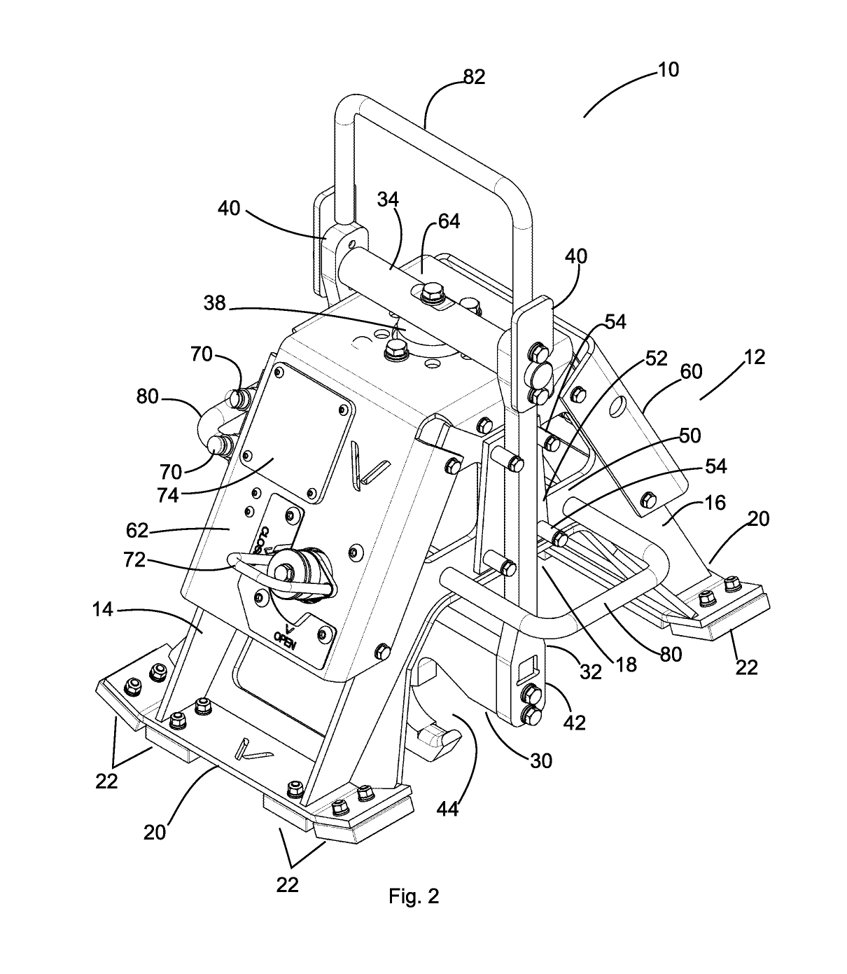

FIG. 3 is a front view of the padeye tester of FIG. 1;

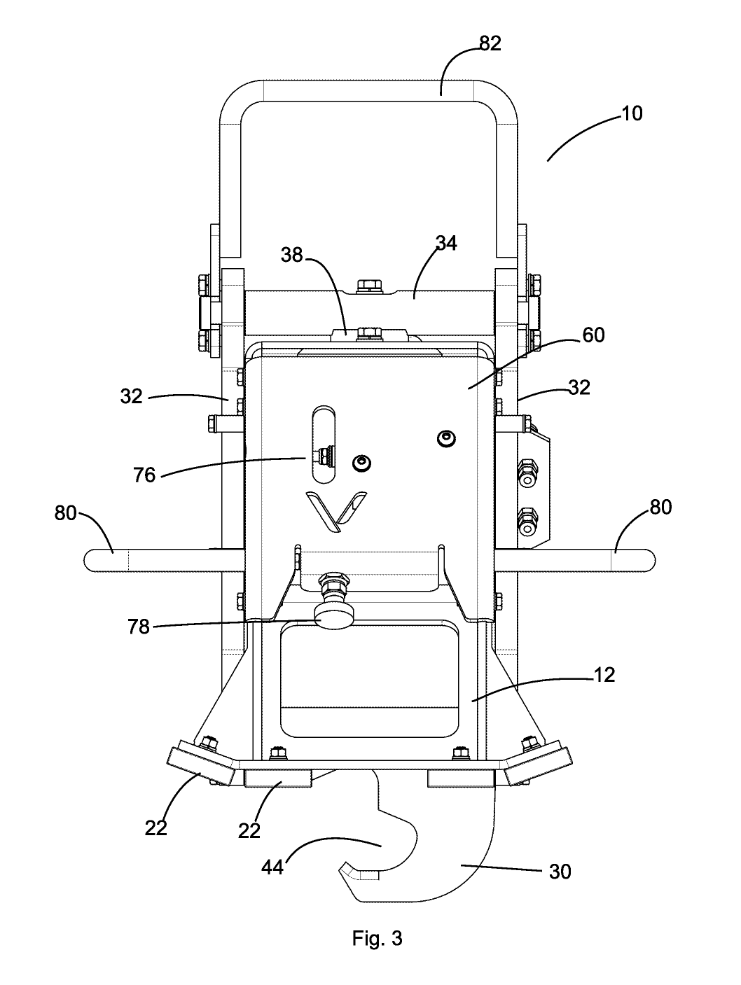

FIG. 4 is a rear view of the padeye tester of FIG. 1;

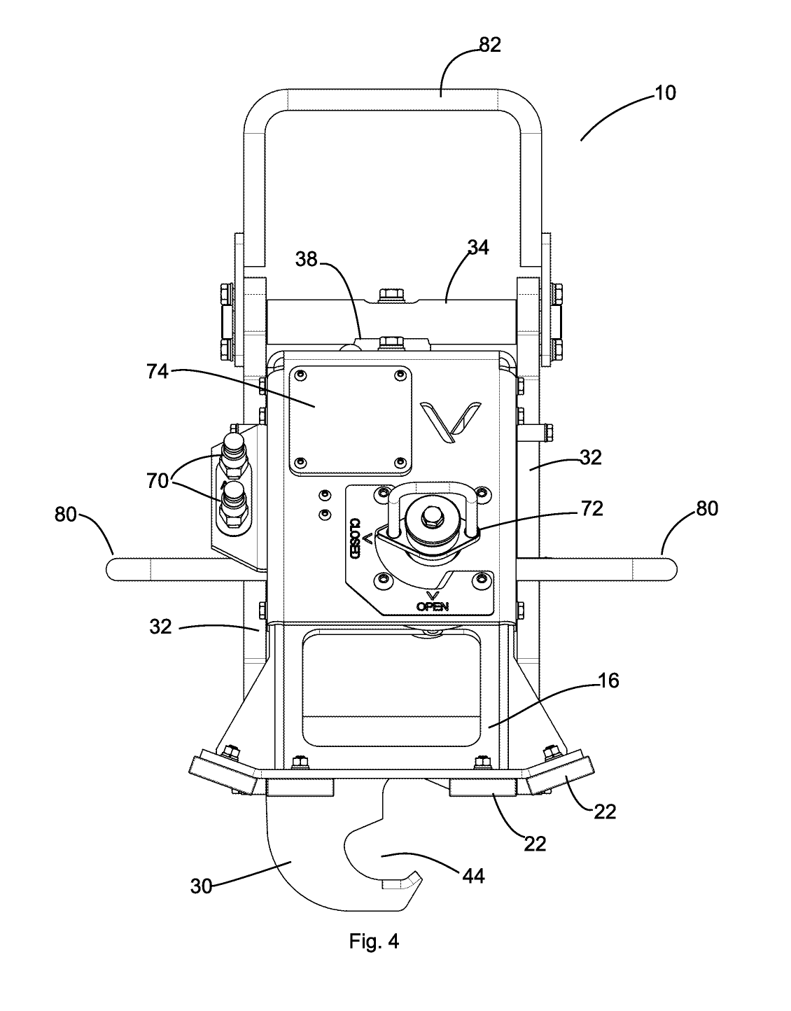

FIG. 5 is a first side view of the padeye tester of FIG. 1;

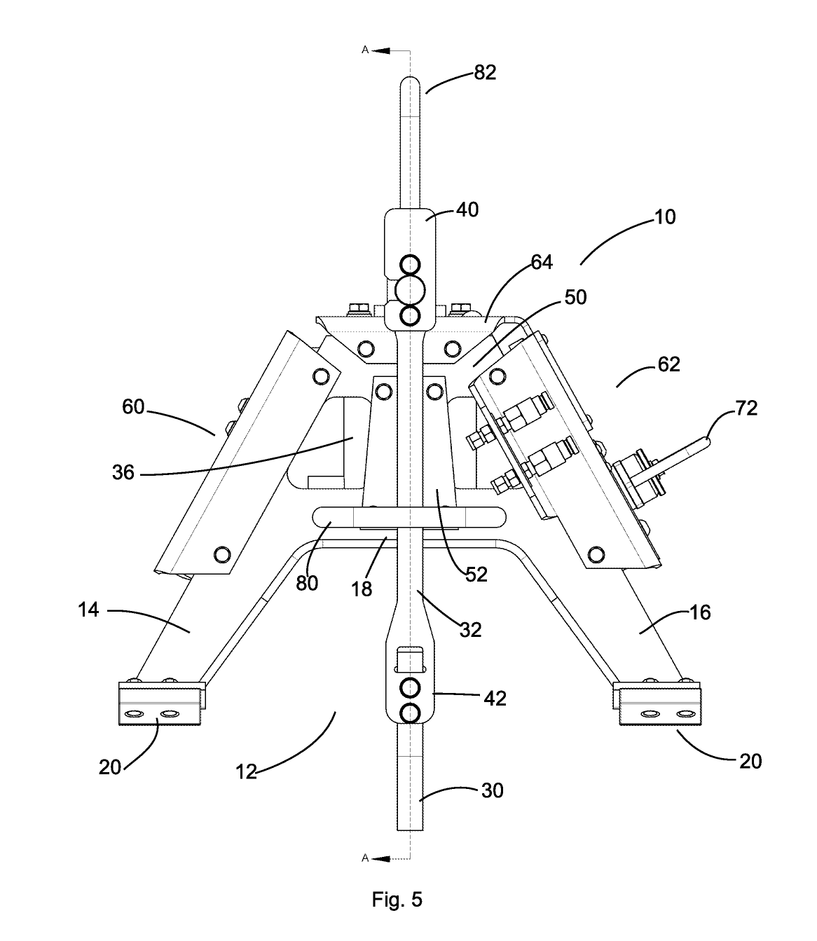

FIG. 6 is a second side view of the padeye tester of FIG. 1; and

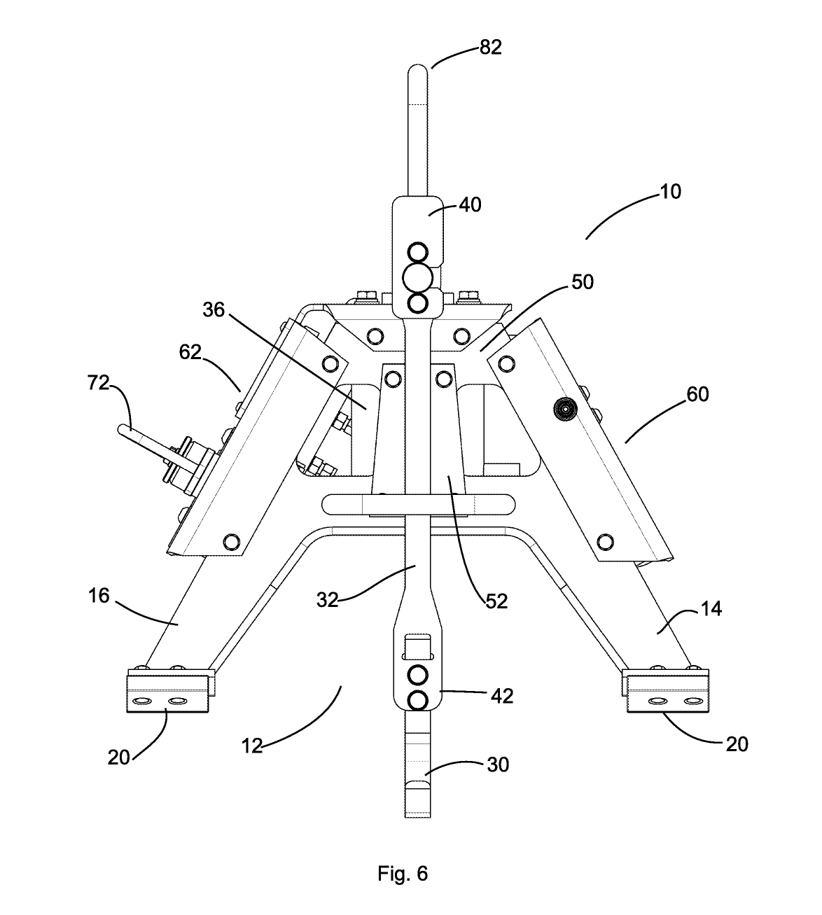

FIG. 7 is a cross section through line A-A of FIG. 1.

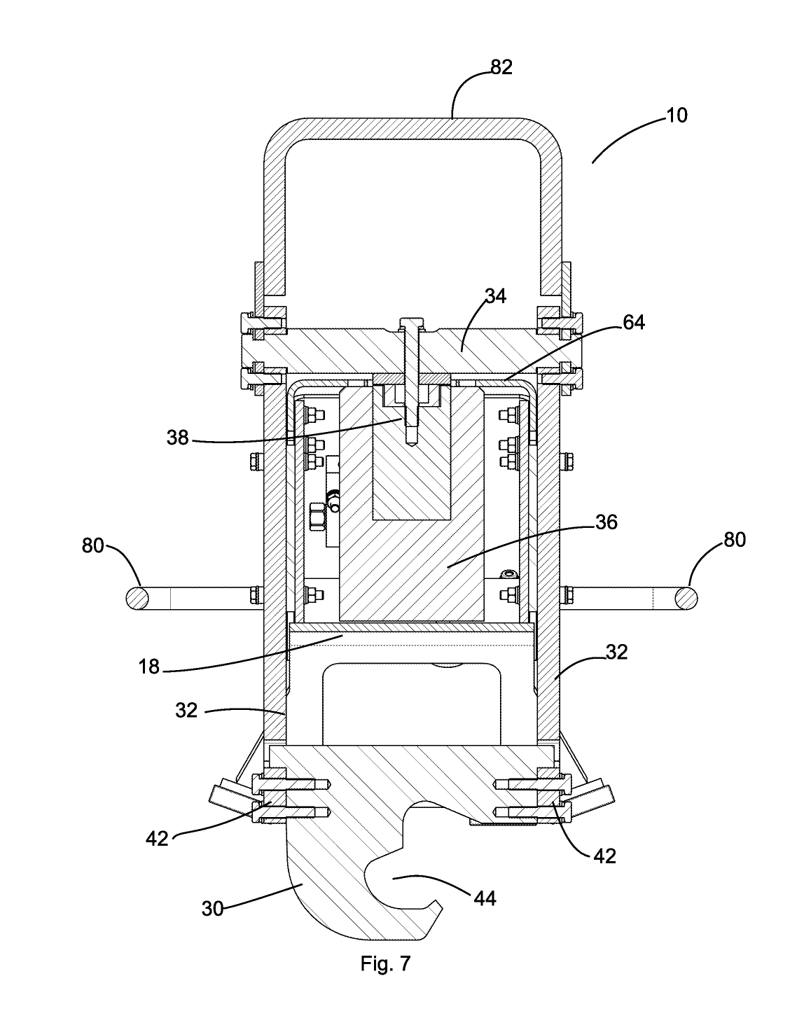

### DETAILED DESCRIPTION OF PREFERRED EMBODIMENTS

Referring to the Figures, there can be seen a padeye tester 10 constructed about a frame 12. The frame 12 is generally V-shaped in cross section, with a front leg 14, a rear leg 16, and a central portion 18. Each of the front leg 14 and rear leg 16 have engagement feet 20 mounted at their outer ends. The engagement feet 20 extend away from the front and rear legs 14, 16 respectively in a direction substantially parallel to the central portion 18. The engagement feet 20 have contact pads 22 spaced along their length.

The arrangement is such that when the contact pads 22 of the engagement feet 20 of both front leg 14 and rear leg 16 are located on an item (not shown), the central portion 18 is located directly above the item.

The padeye tester 10 includes a tension applying mechanism mounted to the central portion 18 of the frame 12. The mechanism includes a padeye engager in the form of a hook 30, located generally beneath the central portion 18 of the frame 12; two lifting arms 32; a force transferring arm 34 and a hydraulic cylinder 36.

The hydraulic cylinder 36 is secured to an upper surface of the central portion 18 of the frame 12. A piston rod 38 extends from an upper end of the hydraulic cylinder 36, such that when hydraulic pressure is applied to the hydraulic cylinder 36, the piston rod 38 is urged upwardly away from the frame 12.

The force transferring arm 34 is generally perpendicular to the hydraulic cylinder 36, and is mounted to the piston rod 38 such that the force transferring arm 34 moves with the piston rod 38. The force transferring arm 34 extends from one side of the frame 12 to the other, such that either end of the force transferring arm 34 extends slightly beyond the central portion 18 of the frame 12, with the piston rod 38 being mounted in the middle of the force transferring arm 34.

The two lifting arms 32 extend from upper ends 40 located at respective ends of the force transferring arms 34 in a direction parallel to the hydraulic cylinder 36, past respective sides of the central portion 18 of the frame 12, to terminate at lower ends 42 beneath the central portion 18 of the frame 12.

The hook 30 is mounted between the lower ends 42 of the lifting arms 32. The hook 30 is formed from a plate material, oriented to be in a plane generally parallel to both the force transferring arm 34 and the lifting arms 32. The hook 30 includes a cut out portion 44 extending inwardly from a side edge of the plate material arranged, in use, to locate about a padeye.

The piston rod 38, force transferring arm 34, lifting arms 32 and hook 30 are all rigidly connected together, and constrained to move together, such that the supply of hydraulic pressure to the hydraulic cylinder 36 results in upward movement of the hook 30.

The frame 12 includes generally trapezoidal side walls 50 which extend above the central portion 18 on either side of the hydraulic cylinder 36, and the edges of which act as extensions of the front and rear legs 14, 16. Each of the side walls 50 has a guide pad 52 mounted on its outer side. The guide pads 52 each have four guide bolts 54 projecting outwardly therefrom, which act to form side barriers to constrain a lifting arm 32 in vertical orientation.

The tester 10 has a front cover 60, a rear cover 62 and a top cover 64. The front cover 60 extends upwardly from the front leg 12, generally in line with the front leg 12, and supported by front edges of the side walls 50. The rear cover 62 similarly extends upwardly from the rear leg 14, generally in line with the rear leg 14 and supported by rear edges of the side walls 50. The top cover 64 extends across the top of the hydraulic cylinder 36, between top edges of the side walls 50. The top cover 64 is parallel to the central portion 18 of the frame 12, and includes a central aperture through which the piston rod 38 can extend.

Hydraulic lines (not shown) are located within the front cover 60 and rear cover 62. The rear cover 62 includes ‘Quick Connect (QC)’ hydraulic couplings 70 for connection to a hydraulic fluid supply; a hydraulic isolation valve 72; and a hydraulic pressure gauge 74. It will be appreciated that the QC fittings could be replaced with a ‘hot stab’ hydraulic coupling if desired. The front cover 60 includes a pressure regulating valve 76 and a flow control valve 78.

The padeye tester 10 also includes handles for ROV use. These include two side handle 80 mounted to respective side walls 50, and a top handle 82 mounted to the upper ends 40 of the lifting arms 32.

In use, the padeye tester 10 is carried by an ROV, by means of the top handle 82, to a subsea structure having a padeye. The ROV positions the padeye tester on the structure such that the engagement feet 20 are located on the structure, and the hook 30 is positioned next to the padeye with the cut out portion being oriented towards the padeye. The ROV then uses the top handle 82 and side handles 80 to manoeuvre the padeye tester into a position in which hook 30 is positioned about the padeye.

The ROV can then open the isolation valve 72, and apply hydraulic fluid to the hydraulic cylinder 36 by means of the QC couplings 70. This will cause the hook 30 to lift, and tension to be applied to the padeye.

The pressure gauge 74 can be used to determine that hydraulic pressure is being applied at an appropriate rate, and is increasing at an expected rate. A lack of resistance will indicate immediate failure of the padeye.

Hydraulic fluid is supplied until a desired pressure is reached. At this point, the isolation valve 72 can be closed. The pressure on the gauge 74 should continue to be observed. If this pressure remains substantially constant for the duration of the test, then the padeye has not failed. A reduction in pressure during the test indicates yielding of the padeye.

Following testing, the pressure can be relieved and the padeye tester 10 removed by the ROV.

Modifications and variations as would be apparent to a skilled addressee are deemed to be within the scope of the present invention.

1. A padeye tester, the padeye tester having: a frame, the frame including engagement feet for engaging with an item; and a padeye engager, the padeye engager arranged to engage with a padeye fixed to the item; the padeye engager being arranged to move relative to the frame such that a tensile force can be applied to the padeye; the padeye tester having a control means whereby the degree of tensile force applied can be controlled.

2. A padeye tester as claimed in claim 1, wherein the padeye includes a gauge whereby any changes in the resistance to the applied force can be determined.

3. A padeye tester as claimed in claim 1, wherein the padeye engager is moved by means of hydraulic pressure.

4. A padeye tester as claimed in claim 1, wherein, the frame is substantially V-shaped, with engagement feet located on both a front leg and rear leg of the frame.

5. A padeye tester as claimed in claim 4, wherein the padeye engager be associated with a central portion of the frame, located between the front leg and the rear leg.

6. A padeye tester as claimed in claim 5, wherein the padeye engager is coupled to a hydraulic cylinder located atop the central portion of the frame.
